(19) United States
(12) Patent Application Publication
(10) Pub. No.: US 2001/0052187 A1
(43) Pub. Date: Dec. 20, 2001

(54) Lockable blade for pocketknife

(76) Inventor: Jorg Eickhorn, Dusseldorf (DE)

Correspondence Address: SCHWEITZER CORNMAN, GROSS & BONDELL LLP, 292 Madison Avenue, 19th Floor, New York, NY, 10017, US

(21) Appl. No.: 09/792,009

(22) Filed: Feb. 21, 2001

(30) Foreign Application Priority Data
Jun. 6, 2000 (DE) 200 09 874.8

(51) Int. Cl. B26B 1/04

(52) U.S. Cl. 30/161

(57) ABSTRACT

The invention relates to a blade for a folding knife with at least one hole passing through the blade, the edge of the hole having at least one dent-like or nose-shaped recess or in which the hole with the nose-shaped or dent-like a recess is an elongated hole. The blade can be locked in position and yet can be easily and cheaply produced.

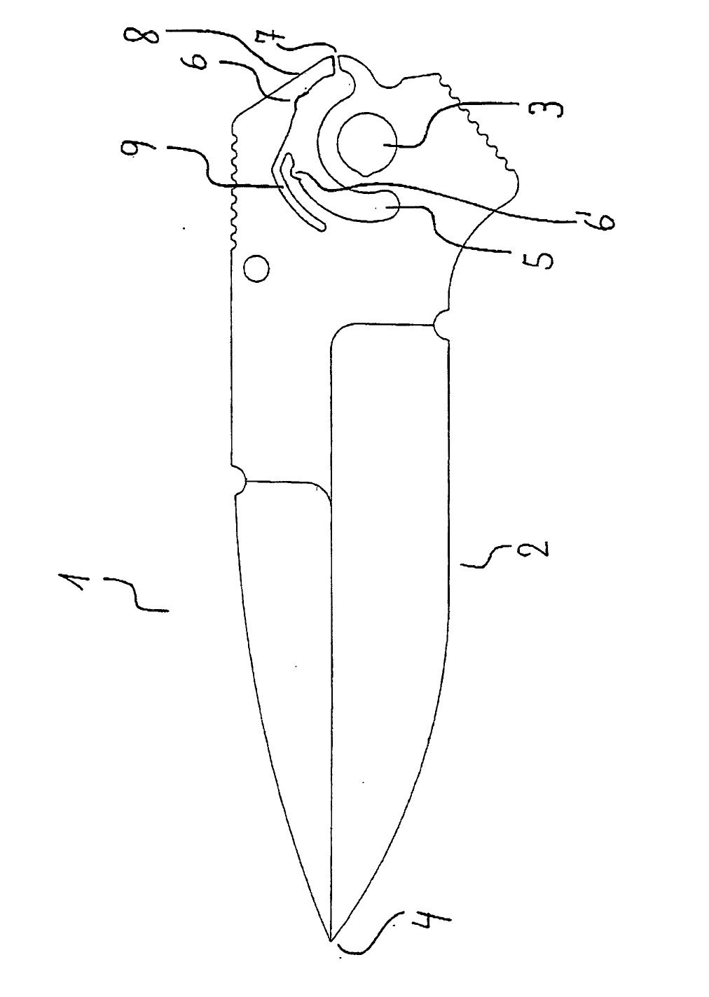

The invention relates to a blade for a folding knife. A folding knife is a knife in which the blade can be retracted into the handle of the knife by a pivoting action. Conversely the blade is made available for use by pivoting it out of the handle.

Examples of such a folding knives are given by pocket knives, or penknives, in which it must be possible to carry it around with one, for example in a trouser pocket, without the blade causing damage or injury. Folding knives of larger dimensions are used for example in hunting.

A folding knife has a blade of which the sharply ground portion is called the cutting edge. Generally the cutting edge extends in a straight line from the handle, in order for example to lead in an arc to the free end forming a point. The end opposite to this point serves for attaching the blade to the handle and is called the hilt. In the case of a blade for a folding knife, such a blade generally has a hole through the hilt. A pin or screw present in the handle extends for example through this hole. The knife can then be folded about the pivot point.

The handle of a knife, made for example of U shape, has on one side a slot which is matched to the length and thickness of the blade. It is arranged so that the cutting edge of the blade can be pivoted into this slot. When the blade is in the slot it cannot be pushed in further as this is prevented by appropriate means. For example this is prevented in that the cutting edge strikes the bottom of the slot. In this way an end position is achieved for the blade in the folded state.

When the blade is unfolded it usually reaches a second end position in which the handle of the knife and the blade form approximately a straight line. Further pivotal movement beyond the straight line is prevented for example in that the blunt side opposite the cutting edge engages against a stop in the handle.

In order to provide stops for the two stated end positions, in one blade according to the state of the art there is for example provided an elongated hole which extends in an arc around the hole through the blade, mentioned earlier. Then a second pin or screw is provided in the handle, passing through the elongated hole. The extent of the elongated hole is chosen so that the pin or screw reaches one or the other end of the hole when the blade arrives in the one or the other of the above-mentioned end positions.

A folding knife according to the state of the art furthermore includes additional means to hold the blade at least in the two end positions. By the word holding it is to be understood that the blade is in fact restrained in an end position but that this restraint can be overcome by exerting a sufficiently large force without thereby damaging the knife. Such holding or restraint is provided so that the blade does not swing freely or pivot inadvertently from one end position towards the other. In fact if a blade is not securely held in the desired position this represents a safety risk or risk of injury.

Means for restraint in the sense stated above are known comprising for example a ball or half-ball secured inside the handle so that it presses against the face of the blade. Recesses are provided at the appropriate points in the face of the blade. When a blade reaches an end position the ball or half-ball in the handle engages in the recess in the face of the blade as a result of a suitable spring-loaded mounting. The blade is then located so securely that it cannot for example move away from the end position as a result of gravity. However if force is used to urge the blade towards the other end position the ball or half-ball is able to disengage from the recess. The restraint thereby ceases.

To hold it in the other end position a further suitably placed recess can be provided in the blade. When the blade is present in the other end position the ball or half-ball enters this further recess.

If further positions in which the blade can be located are to be provided between these two end positions corresponding further recesses are provided in the surface of the blade.

The above-mentioned state of the art has the drawback that in addition to the two pins or screws as well as the two holes (the through-going hole and the elongated hole) additional means are provided to achieve the location. The provision of recesses in the surface of the blade requires three-dimensional machining of the region of the blade provided for attachment to the handle. Such three-dimensional machining is relatively expensive. Also the provision of a ball or half-ball inside the handle adds to the cost.

It is the aim of the invention to provide a blade for a folding knife designed to allow simpler and more economical production of the knife in comparison with the above-mentioned state of the art.

The aim of the invention is achieved by a blade having the features of the first claim. Preferred embodiments are revealed by the subsidiary claims.

The blade according to the claim has—as described above—an elongated hole. This elongated hole extends in an arc about the axis around which the blade is pivoted when it is connected to the handle of a folding knife. The lateral boundary of the elongated hole therefore likewise extends correspondingly in an arc. In contrast to the state of the art the elongated hole has in addition on its arcuate edge dent-like or nose-shaped recesses. These recesses are placed in such a way that the pin or screw in the handle of the knife which passes through this elongated hole extends into a dent-shaped or nose-shaped recess when the desired locating position for holding the blade is reached. The pin and blade are then arranged so that, in co-operation with the handle of a folding knife, the pin is resiliently engaged in the dent-shaped or nose-shaped recess when the blade is held. This spring force is overcome by exerting a force and the pin is able to leave the recess. It is then present again in the part of the elongated hole which has an arcuate boundary but is clear of the dent-shaped or nose-shaped recess. In this region, however, friction forces still need to be overcome in order to pivot the blade.

A restraint or holding action is therefore achieved in that the corresponding pin or screw in the handle enters the dent-shaped or nose-shaped recess in such a way that pre-loaded spring action is relieved, and now a force beyond the normal friction force needs to be exerted against the resilient restraint in order to cause the blade to leave the position it has adopted.

The desired spring action can be achieved in a particularly simple manner if the elongated hole narrows at the nose-shaped or dent-like recess and the material of the blade is sufficiently elastic. When the pin reaches the nose-shaped or dent-like recess, the spring force builds up as a result of the constriction and the elasticity of the material. This spring force is relieved as soon as the pin or screw reaches the recess.

In a further preferred embodiment of the invention the elongated hole has a slot associated with it. This slot leads out of the elongated hole and out of the blade. The slot is very small in relation to the pin or screw in the handle which extends through the elongated hole. By the presence of such a slot it is possible for the elongated hole to be widened out slightly by the use of force, when steel is used as the material of the blade

In order to achieve the desired spring action, as an alternative to constriction of the elongated hole one can simply provide a suitable arcuate profile of one edge of the elongated hole. What is important is that the arcuate edge with the dent-like or nose-shaped extent presses resiliently against the corresponding pin or screw at least when the pin or screw moves along the elongated hole.

The invention is based on the following principle. A pin is provided in the handle of a knife. This pin is guided to slide along a smooth edge. It enters the dent-like or nose-shaped recess in the edge as soon as the blade has reached a position in which it is to be locked or restrained.

This principle could be applied also to the other hole in the blade through which the pin or screw passes, and around which the blade pivots. This round hole can have nose-shaped or dent-like recesses. Then if the pin has corresponding projecting locking noses pressing resiliently against the edge of the hole, the principle is likewise achieved.

A hole will generally have at least two nose-shaped or dent-like recesses, in order to provide at least two locating positions. In fact the blade should be held at least in the two end positions the. In addition one or more intermediate positions could be provided.

The slot which extends from the elongated hole is typically present at one end of the hole. This is the end which at the same time lies furthest from the pointed end of the blade. However the slot could for example be provided half way along the arcuate extent of the boundary of the elongated hole.

The invention is further explained in the following in conjunction with an embodiment by way of example.

The figure shows a blade l, provided for a folding knife. The blade 1 has a sharp ground edge 2 which forms the cutting edge. At one end the blade 1 has a hole 3 through it. This hole 3 passes through the material of the blade. When the blade I is connected to the handle of a knife, a pin or screw extends through the hole 3. The blade can then pivot about this pin. The cutting edge 2 extend initially in a straight line and then leads in an arc into a tip 4. This tip 4 forms the end of the folding knife in its opened-out state.

An elongated hole 5 extends in an arc around the hole 3. The elongated hole has at one position in its outer periphery a first nose-shaped or dent-like recess 6. Furthermore a second such nose-shaped or dent-like recess 6′ is present approximately midway between the two ends of the hole 5. At one end of the hole there is a slot 7 extending from the hole. It is present at the end of the blade lying furthest from the tip 4.

It is clear from the figure that in the region of the handle the blade only has to be a machined in two dimensions. What is meant by this is that no additional recess has to be milled out of the face of the blade. The elongated hole together with the dent-like recess can be produced in a single working step. The same is true of the slot 7. Accordingly the cost of manufacture is low.

The width of the slot 7 is a very small in comparison with the width of the elongated hole 5, The slot 7 is therefore substantially smaller than the pin or screw which passes through the hole 5.

The invention can also be put into practice with the slot 7 significantly larger. However this is less attractive in fact, for reasons of manufacture.

The first nose-shaped or dent-like recess 6 is made semi-circular in the present case. This semi-circular shape ensures that the pin or screw which enters the recess 6 with the blade in its located position can also disengage from the recess when a force is applied. What is important is that the shape of the recess 6 is not such that the pin or screw pressed resiliently into it becomes hooked into this recess 6. That would mean the pin or screw could in fact no longer disengage from the recess 6 and so it would no longer be possible to release the restraint by applying a force.

The outer rim of the elongated hole 5 runs so that the pin or screw which passes through this hole in the folding knife presses resiliently against the outer rim at least when it is in the neighbourhood of the recess 6. When the pin or screw is aligned with the recess 6, it is pressed into the recess by the spring action. The spring action is achieved by the fact that the flank 8 of the hole 5 can deflect outwards elastically to a limited extent. The slot 7 is provided in order to allow this deflection of the flank 8.

So that an elastic spring action is achieved also in the region of the second nose-shaped or dent-like recess 6′, which is present approximately midway between the two ends of the hole 5, an elongated recess 9 is provided. This recess 9 extends, and opens into the hole 5, in such a way that the second recess 6′ is present in a thin elongated part having a free end. As this part is long and thin and furthermore can deflect into the recess 9, the desired elastic or spring action is achieved likewise here.

As a rule a number of nose-shaped or dent-like recesses 6 are provided in order to give different locating positions.

Apart from the holes in the blade together with the associated pin or screw in the handle of the knife, no further means are required in order to allow the blade to be located in desired positions. This represents a significant simplification over the state of the art.

1. Blade for a folding knife with at least one hole (5), which passes through the blade (1), the edge of the hole (5) having at least one dent-like or nose-shaped recess (6)

2. Blade according to claim 1, in which the hole (5) having the nose-shaped or dent-like recess (6) is an elongated hole.

3. Blade according to claim 1 or 2, in which at least two holes are provided in the area of the blade which is provided for attachment of a knife handle.

4. Blade according to one of the foregoing claims, in which an elongated hole (5) extends in an arc about a hole (3).

5. Blade according to one of the foregoing claim, in which an elongated hole (5) is provided with a slot (7) extending from the elongated hole.

6. Blade according to one of the foregoing claims, the blade being connected foldably to the handle of a knife.

7. Folding knife with a blade according to one of the foregoing claims and having a pin or screw which is pressed resiliently against the edge of the hole (5) adjacent to the dent-like or nose-shaped recess (6).
